(19) United States
(12) Patent Application Publication
(10) Pub. No.: US 2016/0066662 A1
(43) Pub. Date: Mar. 10, 2016

(54) DECORATIVE ARTICLES

(71) Applicant: SPECTORE CORPORATION, Deerfield Beach, FL (US)

(72) Inventors: Edward Rosenberg, Delray Beach, FL (US); Joseph R. Sootsman, Freeland, MI (US); Ryan J. Smith, Midland, MI (US); Daren W. Roehl, Midland, MI (US); Vasgen A. Shamamian, Midland, MI (US)

(21) Appl. No.: 14/844,371

(22) Filed: Sep. 3, 2015

Related U.S. Application Data
(60) Provisional application No. 62/045,921, filed on Sep. 4, 2014.

(51) Int. Cl. A44C 9/00; B32B 3/08; B32B 7/12; A44B 5/00; B32B 9/04; B32B 15/04; B32B 17/06; B32B 3/30; B32B 9/00

(52) U.S. Cl. CPC A44C 9/00; B32B 3/30; B32B 3/08; B32B 7/12; B32B 9/002; B32B 9/041; B32B 15/043; B32B 17/061; B32B 9/04; A44B 5/00; B32B 2255/26; B32B 2255/06; B32B 2307/412; B32B 2451/00

(57) ABSTRACT

The present application discloses new decorative articles. The decorative articles may have a base having a reflective upper surface. The decorative articles may include at least one an aesthetic item located at least proximal the reflective upper surface of the base. The decorative articles may include an affixing material disposed on the reflective upper surface of the base, wherein the affixing material fixes the aesthetic item in a predetermined orientation relative to the reflective upper surface.

### CROSS-REFERENCE TO RELATED APPLICATION

This patent application claims benefit of priority of U.S. Provisional Patent Application No. 62/044,921, filed Sep. 4, 2014, entitled “IMPROVED DECORATIVE ARTICLES”, which is incorporated herein by reference in its entirety.

### BACKGROUND

According to Polygon (www.polygon.net), total fine jewelry and watch sales in the United States grew to an estimated $71.3 billion in 2012, with the United States being the world's largest consumer of diamond jewelry, and with total yearly sales revenue in the area of $27 billion, accounting for 40% of total global demand. Demand remains for new and improved jewelry items.

### SUMMARY OF THE DISCLOSURE

Broadly, the present patent application relates to new decorative articles. One example of a new decorative article is illustrated in FIGS. 1a-1b. In the illustrated embodiment of FIGS. 1a-1b, the decorative article (10) includes a base (20), an aesthetic item (30), and an optional cover (40). The base (20) generally includes a reflective upper surface (22), a lower surface (24), and at least one outer edge (26). The decorative article (10) further includes an affixing material (not illustrated) disposed on at least a portion of the reflective upper surface (22) of the base (20). The affixing material generally fixes the aesthetic item (30) in a predetermined orientation relative to the reflective upper surface (22). Thus, the aesthetic item (30) is located at least proximal the reflective upper surface (22).

As used herein, “decorative article” and the like means an article whose intended final use is predominately for decorative purposes. Examples of decorative articles include jewelry, decorative attachments and decorative cases (e.g., attachments, handles, or cases for writing instruments), such as any of a ring, bracelet, collar, earing, pendant, cufflink, pen handle or attachment, encasements, and watch components (e.g., dials, faces, accents), among others. For purposes of this patent application, “decorative articles” do not include predominately functional items such as, for instance, valves, gears, screws, turbines, tools, cutlery, cookware, solar panels, medical equipment, and electronic parts (e.g., semiconductor chips, field emission cathodes), among others. Decorative articles include articles with ancillary functionality, such as articles having tracking technology included therein. For instance, a decorative article in the form of a collar may have a transmitter included with the collar. In this regard, the decorative article provides the predominate visual appearance while the ancillary functionality is hidden, or is incidental to the appearance of the decorative article.

### The Base Material

The base (20) of the decorative article (10) may be any material having a suitable reflectivity for reflective upper surface (22). The reflective upper surface (22) may facilitate enhanced visual appeal for aesthetic item (30). In one embodiment, the base (20) comprises a silicon eutectic alloy, defined below. In one embodiment, the base (20) consists essentially of silicon eutectic alloy. In another embodiment, the base (20) comprises (and sometimes consists essentially of) a glass. In yet another embodiment, the base (20) comprises (and sometimes consists essentially of) a metal or a metal alloy. In another embodiment, the base (20) comprises (and sometimes consists essentially of) an intermetallic composite. In one embodiment, the base (20) is in the form of a solid, monolithic material. In another embodiment, the base (20) is in the form of a film (e.g., a film located on another substrate). In this embodiment, the base (20) may be produced, for example, by depositing the film on a substrate. The film embodiments may be useful, for instance, when the material of the base (20) is expensive and/or is difficult to produce as a solid, monolithic material.

As used herein, a “silicon eutectic alloy” is an alloy having an aggregation of a first silicon phase and a second disilicide phase dispersed within the first phase. A silicon eutectic alloy does not have to be “perfectly eutectic”, i.e., a silicon eutectic alloy does not need to have a composition that is located perfectly on the eutectic point of its corresponding phase diagram. For example, a Si—CrSi₂ eutectic alloy has one eutectic point at about 24 wt. % Cr and 76 wt. % Si. However, compositions outside of this point may produce acceptable silicon eutectic alloys having a defined aggregation of a first phase and a second phase dispersed within the first phase. Three or more distinct phases may also be present. Some methods for producing silicon eutectic alloy products are disclosed in, for instance, WO2011/022058 to Schuh et al. and U.S. Pat. No. 4,724,233 to Ditchek et al, each of which is incorporated herein by reference in its entirety.

In one embodiment, the silicon eutectic alloy comprises a eutectic aggregation of silicon and disilicides of a formula MSi₂, wherein M is a metallic element, described below. The silicon eutectic alloy includes a second phase comprising one or more disilicides, this second phase being sometimes referred to herein as reinforcement structures. Such reinforcement structures may have a high aspect ratio (e.g., in the form of rods and/or lamella and/or combinations thereof). The metallic element M may be any suitable element that can form a eutectic aggregation of silicon and disilicides. In one embodiment, the metallic element M is selected from the group consisting of chromium, titanium, cobalt, vanadium, niobium, platinum, palladium, tantalum, zirconium, and combinations thereof. In one embodiment, the metallic element M is cobalt (e.g., when the upper reflective surface is configured to comprise a bluish hue), and the disilicide is CoSi₂. In one embodiment, the metallic element M is titanium, and the disilicide is TiSi₂. In one embodiment, the metallic element M is chromium, and the disilicide is CrSi₂. In one embodiment, the metallic element is vanadium, and the disilicide is VSi₂. In one embodiment, the metallic element is niobium, and the disilicide is NbSi₂. In one embodiment, the metallic element is platinum, and the disilicide is PtSi₂. In one embodiment, the metallic element is palladium, and the disilicide is PdSi₂. In one embodiment, the metallic element is tantalum, and the disilicide is TaSi₂. In one embodiment, the metallic element is zirconium, and the disilicide is ZrSi₂.

In one approach, the silicon eutectic alloy is a binary alloy having silicon and one metallic element M, such as any of the Si—CoSi₂, Si—TiSi₂, Si—CrSi₂, Si—VSi₂, Si—NbSi₂, Si—PtSi₂, Si—PdSi₂ Si—TaSi₂, and Si—ZrSi₂ alloys described above. In another approach, the silicon eutectic alloy is a ternary alloy having the silicon phase, the disilicide phase, and a third alloying element. The third alloying element may be selected from the group consisting of aluminum, silver, gold, and combinations thereof. In one embodiment, the third alloying element is aluminum. In one embodiment, the third alloying element is silver. In one embodiment, the third alloying element is gold. In this approach, the metallic element M of the disilicide phase may be any of the metals described above, i.e., any of chromium, titanium, cobalt, vanadium, niobium, platinum, palladium, and combinations thereof. In one embodiment, the metallic element M of the disilicide phase is selected from the group consisting of chromium, titanium, and cobalt.

The third alloying element may be included in the silicon eutectic alloy in the range of from about 0.05 to about 10 wt. %. The amount of the third alloying element is calculated based on the total weight amount of silicon and metallic element in the silicon eutectic alloy. For example, using a silicon-titanium eutectic alloy having additional aluminum as a basis for illustration, if a silicon-titanium eutectic alloy included 78.3 grams of silicon and 21.7 grams of titanium (includes slightly excess silicon to account for Si—Al eutectic), then the silicon eutectic alloy would have 100 grams of silicon+titanium. For this silicon-titanium eutectic alloy to have, by way of example, 4.0 wt. % Al, an additional 4.0 grams of aluminum would be added to this 100 grams of Si+Ti (4.0 grams of aluminum divided by 100 grams of Si+Ti=4 wt. % Al). Slightly excess silicon may be added to compensate for the addition of the third alloying element. For example, when aluminum is used as the third alloying element, about 0.13 times the weight amount of aluminum may be added to compensate for silicon-aluminum eutectic that may be formed due to the addition of the aluminum. A similar approach may be employed for silver and gold, where excess silicon of about 0.31 times the weight amount of silver may be added when silver is employed, and where excess silicon of about 0.32 times the weight of gold may be added when gold is employed.

In one embodiment, a ternary silicon eutectic alloy (or a body made therefrom) includes not greater than 8 wt. % of the third alloying element. In another embodiment, a ternary silicon eutectic alloy (or a body made therefrom) includes not greater than 6 wt. % of the third alloying element. In yet another embodiment, a ternary silicon eutectic alloy (or a body made therefrom) includes not greater than 5.0 wt. % of the third alloying element. In another embodiment, a ternary silicon eutectic alloy (or a body made therefrom) includes not greater than 4.0 wt. % of the third alloying element. In yet another embodiment, a ternary silicon eutectic alloy (or a body made therefrom) includes not greater than 3.0 wt. % of the third alloying element. In another embodiment, a ternary silicon eutectic alloy (or a body made therefrom) includes not greater than 2.5 wt. % of the third alloying element. In one embodiment, a ternary silicon eutectic alloy (or a body made therefrom) includes at least 0.10 wt. % of the third alloying element. In another embodiment, a ternary silicon eutectic alloy (or a body made therefrom) includes at least 0.25 wt. % of the third alloying element. In yet another embodiment, a ternary silicon eutectic alloy (or a body made therefrom) includes at least 0.35 wt. % of the third alloying element. In another embodiment, a ternary silicon eutectic alloy (or a body made therefrom) includes at least 0.50 wt. % of the third alloying element.

In another embodiment, the base (20) comprises (and sometimes consists essentially of) a glass. Examples of suitable glass materials include soda-lime glass, borosilicate glass, lead glass, aluminosilicate glass, and fused silica glass, among others.

In one embodiment, the base (20) comprises (and sometimes consists essentially of) one of a metal or a metal alloy. Examples of suitable metals for the metal or metal alloy include silicon (but not silicon eutectic alloys, which are a separate category, as described above), titanium, gold (including white gold), silver, copper, platinum, palladium, cobalt, aluminum, and rhodium.

In one embodiment, the base (20) comprises (and sometimes consists essentially of) an intermetallic composite. In one embodiment, the intermetallic composite is tungsten carbide (WC).

The base (20) may be of any suitable shape for the decorative article (10). In the illustrated embodiment of FIGS. 1a-1b, the base (20) is generally cylindrical. However, any other suitable shape may be utilized. Furthermore, although only one base (20) is illustrated in FIGS. 1a-1b, multiple bases (20) may be used in a single decorative article (10), and these bases (20) may be comprises of the same base material, or different base materials, such as any of the base materials described above. Further, while the base (20) is generally described with the reflective upper surface (22) being the main viewing surface, in other embodiments, the base (20) can include multiple reflective viewing surfaces including any combination of upper, lower, and side surfaces.

The reflective upper surface (22) of the base may be of any suitable contour. In the illustrated embodiment of FIGS. 1a-1b, the reflective upper surface (22) is generally planar. However, other contours may be used, such as one or more bumps or recesses on the reflective upper surface (22). Further, one or more contours can be used on any portion of the base (20), such as when multiple viewing surfaces are used.

The reflectivity of the base may be produced/enhanced by suitable finishing techniques. For instance, for a silicon eutectic alloy, suitable grinding/polishing techniques (e.g., a 0.05 micron finish—the finishing media has a 0.05 micron size particle) may be used. Other suitable finishing techniques may be used for other base (20) materials. Further, selective finishing may be completed relative to any contour(s) such, as machining, grinding, and/or polishing of any bump(s), plane(s) and/or recess(es) of the base (20).

### The Aesthetic Item(s)

As noted above, the decorative article (10) includes at least one aesthetic item (30). The one or more aesthetic items (30) may be any item or items that is/are decoratively pleasing. For instance, the aesthetic item (30) may be a precious stone, a semi-precious stone, a precious metal, a semi-precious metal, a sculptural item, a natural aesthetic item, a ceramic, a composite, and combinations thereof.

In one embodiment, the aesthetic item (30) comprises a precious stone. Examples of suitable precious stones include diamonds, rubies, sapphires, emeralds. In one embodiment, the aesthetic item (30) comprises a semi-precious stone. Example of semi-precious stones include garnets, cubic zirconia, opals, amethysts, aquamarines, alexandrites, peridots, tourmalines, topaz, citrine, tanzanites, zircons, and turquoise, among others. Lab created (synthetic) stones are semi-precious stones.

Further, when multiple aesthetic items (30) are used in a decorative article (10), the aesthetic items (30) can include multiple precious and/or semi-precious stones, which multiple precious and/or semi-precious stones may be all of the same stone (e.g., all diamonds), or which multiple precious or semi-precious stones may be a combination of different precious and/or semi-precious stones (e.g., at least one diamond with at least one emerald). Non-limiting examples of decorative articles (10) having multiple precious stones are shown in FIGS. 3b, 4, and 5b.

In one embodiment, the aesthetic item (30) comprises a precious metal. Examples of suitable precious metals include the metals and metal alloys of gold (including white gold), silver, platinum, and palladium. In one embodiment, the aesthetic item (30) comprises a semi-precious metal. Examples of suitable semi-precious metals include the metals and metal alloys of copper (e.g., bronze or brass), iron (e.g., steel), titanium, rhodium, zirconium, chromium, cobalt, and aluminum. Further, when multiple aesthetic items (30) are used in a decorative article (10), the aesthetic items (30) can include multiple precious and/or semi-precious metals, which multiple precious and/or semi-precious metals may be all of the same metal (e.g., all gold), or which multiple precious metal may be a combination of different precious and/or semi-precious metals (e.g., at least gold with at least silver).

In one embodiment, the aesthetic item (30) comprises a sculptural item. As used in this patent application, a sculptural item is an object (e.g., a solid object) as a work of art, made by shaping a substance (e.g., made by shaping wood, stone, metal, or other substance into a work of art). The sculptural item may be, for instance, one or more of an animal, a human (including identifying features of all or a portion of one or more famous persons, fictional or non-fictional) (e.g., in the form of a figurine), a landmark (e.g., the Eiffel Tower), an architectural item, a historically significant item (e.g., the Wright Bros. plane), a weapon (e.g., a gun), ammunition, a transportation item (e.g., a motorcycle), sporting equipment and/or activities, logos, cartoons, characters, one or more alpha-numeric characters, symbols, and decorative mechanisms (e.g., gears, circuits), among others. Non-limiting examples of decorative articles (10) having aesthetic items (30) in the form of sculptural items are shown in FIGS. 6a-6c. In another embodiment, the sculptural item may be a geometric object, including triangular solids, rectangular solids, pentagons, hexagon, wires, flakes, and lattices, among others. Further, when multiple aesthetic items (30) are used in a decorative article (10), the aesthetic items (30) can include multiple sculptural items, which multiple sculptural items may be all the same (e.g., all the same figurine), or which multiple sculptural items may be a combination of different sculptural items (e.g., all figurines, with at least one different figurine; one or more figurines with one or more non-figurine items).

In one embodiment, the aesthetic item (30) is at least one of a natural aesthetic item, a ceramic, a composite, and combinations thereof. Examples of natural aesthetic items include pearls, bone, wood, and fossils, among others. Examples of suitable ceramics include alumina, zirconia, silicon nitride and silicon carbide, among others. Examples of suitable composites include tungsten carbide, metal matrix composites and polymer composites, among others. When multiple aesthetic items (30) are used in a decorative article (10), the aesthetic items (30) can include multiple natural aesthetic items and/or ceramics and/or composites, which items may be all the same (e.g., all pearls), or which multiple sculptural items may be a combination of different items (e.g., all natural aesthetic items, with at least one different natural aesthetic item; one or more natural aesthetic items with one or more composites).

As disclosed above, the decorative article (10) includes at least one aesthetic item (30). When the decorative article (10) includes multiple aesthetic items (30), the multiple aesthetic items (30) may be all of the same type (e.g., all precious stones; all semi-precious stones; all precious metals; all semi-precious metals; all sculptural objects; all natural aesthetic items), or the multiple aesthetic items (30) may be a combination of different types, such as any combination of one or more precious stones, one or more semi-precious stones, one or more precious metals, one or more semi-precious metals, one or more sculptural objects, one or more natural aesthetic items, one or more ceramics, and one or more composites.

### The Affixing Material

As disclosed above, the decorative article (10) includes an affixing material (not illustrated) disposed on at least a portion of the reflective upper surface (22) of the base (20), and the affixing material fixes the aesthetic item (30) in a predetermined orientation relative to the reflective upper surface (22). The affixing material may be any material suitable for fixing the aesthetic item (30) in a predetermined orientation relative to the reflective upper surface (22) while allowing for viewing of suitable portions of the aesthetic item (30). Thus, the affixing material is generally in the form of a solid and adherent to the reflective upper surface (22) of base (20). In one embodiment, the affixing material is transparent. In one embodiment, the affixing material is translucent. In one embodiment, the affixing material is at least partially colored. In one approach the affixing material comprises a polymer. In one embodiment, the polymer is an organic polymer. In another embodiment, the polymer is a silicone polymer including thermoplastic silicone polymers, such as poly(diphenylsiloxane-co-phenylmethylsiloxane), and thermoset (cured or cross-linked) silicone polymers such as the cured products thereof (e.g., DOW CORNING silicone polymers MS1001 or MS1002, which are heat-curable moldable optical silicone compositions). The polymers can be cured or cross-linked to form at least a portion the affixing material. In the case of thermoset polymers, the affixing material can be formed by applying a curable composition comprising a thermosetting silicone polymer to at least a portion of the reflective upper surface of the base and curing the thermosetting polymer. The curable composition typically includes a thermosetting silicone polymer and additional ingredients, such as an organic solvent, cross-linking agent, and/or catalyst. Examples of curable compositions comprising thermosetting silicone polymers include, but are not limited to, curable silicone compositions, such as hydrosilylation-curable silicone compositions, condensation-curable silicone compositions, and radiation-curable silicone compositions.

As shown in FIGS. 1a-1b, and as described above, the reflective upper surface (22) may facilitate enhanced visual appeal for aesthetic item (30). In this regard, the affixing material may fix the aesthetic item (30) in a predetermined orientation relative to the reflective upper surface (22). In one embodiment, the affixing material fixes the aesthetic item (30) in a manner that enhances reflectivity and/or viewing of aesthetic item (30), such as by enhancing light reflection of one or more of a side, top and/or bottom surface of the aesthetic item. In one embodiment, the affixing material magnifies at least a portion of the aesthetic item (30).

### The Optional Cover

As disclosed above, the decorative article (10) may include an optional cover (40), which at least partially covers the aesthetic item (30) (e.g., to protect the aesthetic item (30)). The optional cover may connect to the base (20), as shown in FIGS. 1a-1b. In other embodiments, the optional cover (40) may also/alternatively connect to one or more other portions of the decorative article (10). The optional cover (40) is generally transparent to facilitate viewing of at least aesthetic item (30). However, the optional cover (40) may be translucent and/or colored (fully or partially colored). The optional cover may be of any suitable material, such as glass, plastic, quartz, sapphire, or other transparent or translucent material. The optional cover (40) may be of any suitable shape, such as the rounded shape shown in FIGS. 1a-1b.

### Surrounding Material(s) and Human Adornment Apparatus

Referring now to FIG. 2a, another embodiment of a decorative article (10) is illustrated. In the embodiment of FIG. 2a, the decorative article (10) is in the form of a necklace, however, other configurations may be used. Like the decorative article (10) of FIGS. 1a-1b, the decorative article (10) includes at least one base (20), at least one aesthetic item (30), and an affixing material (not illustrated) disposed on at least a portion of the reflective upper surface (22) of the base (20). The affixing material generally fixes the aesthetic item (30) in a predetermined orientation relative to the reflective upper surface (22). Thus, the aesthetic item (30) is located at least proximal the reflective upper surface (22).

In the embodiment of FIG. 2a, the decorative article (10) also includes a surrounding material (50) and a separate human adornment apparatus (60). In the embodiment of FIG. 2a, the surrounding material (50) includes a recess for holding the base (20). In this regard, the surrounding material (50) partially surrounds the base (20), with the reflective upper surface (22) and the aesthetic item (30) remaining visible, but with the outer edge (26) and lower surface (24) of the base being covered via the surrounding material (50).

The surrounding material (50) may be any material that is suited to surround the base (20) and is suited for the decorative article (10). For instance, the surrounding material may include one or more of a metal (precious or non-precious; alloyed or pure), a stone (precious or non-precious), a ceramic, a composite, a resin, an amorphous solid (e.g., glass) or a natural aesthetic item, among other materials.

Still referring to FIG. 2a, the human adornment apparatus (60) of the decorative item (10) is connected to the base (20) via the surrounding material (50). As used herein, “human adornment apparatus” and the like means an apparatus (a) that is connected (directly or indirectly) to the base (20) of the decorative article (10), and (b) is for the purpose of facilitating a human to wear the decorative article (10). Examples of human adornment apparatus include clasps and rings, among others. The human adornment apparatus (60) of FIG. 2a, which is in the form of a clasp, is indirectly connected to the base (20). However, in other embodiments, a human adornment apparatus may be directly connected to the base (20).

Referring now to FIG. 2b, the surrounding material (50) may include multiple distinct portions. In the illustrated embodiment of FIG. 2b, the surrounding material includes an inner ring portion (52), a middle portion (54), and an outer ring portion (56). In the illustrated embodiment of FIG. 2b, the inner ring portion (52) and outer ring portion (56) may be of a first material, and the middle portion (54) may be of a second material, different than the first material of the inner and outer ring portions (52, 56). Thus, the surrounding portion (50) may include multiple distinct portions.

Referring now to FIG. 3a, another embodiment of a decorative article (10) in the form of a ring is illustrated. Like the decorative article (10) of FIG. 2a, the decorative article (10) includes at least one base (20), at least one aesthetic item (30), and an affixing material (not illustrated) disposed on at least a portion of the reflective upper surface (22) of the base (20). The affixing material generally fixes the aesthetic item (30) in a predetermined orientation relative to the reflective upper surface (22). Thus, the aesthetic item (30) is located at least proximal the reflective upper surface (22). In the embodiment of FIG. 3a, the ring includes a base (20) located on an upper surface of the ring. The ring also includes a surrounding material (50) having a recess for holding the base (20), and an integral human adornment apparatus (60) (i.e., the surrounding material forms at least a portion of the human adornment apparatus (60)). In the illustrated embodiment, the human adornment apparatus (60) is in the form of a ring. Thus, the surrounding material (50) and the human adornment apparatus (60) may be integral, and the surrounding material (50) and the human adornment apparatus (60) together may be monolithic. The illustrated embodiment of FIG. 3a also includes optional cover (40). In other embodiments (not illustrated), the surrounding material (50) and the human adornment apparatus (60) may be non-integral, such as when a separate ring is attached to the bottom of surrounding material.

Referring now to FIG. 3b, another embodiment of a decorative article (10) in the form of a ring is illustrated. The illustrated embodiment of FIG. 3b is similar to that of FIG. 3a, except that multiple aesthetic items (30) are included.

Referring now to FIG. 4, another embodiment of a decorative article (10) in the form of a ring is illustrated. Like the decorative article (10) of FIG. 2a, the decorative article (10) includes at least one base (20), at least one aesthetic item (30), and an affixing material (not illustrated) disposed on at least a portion of the reflective upper surface (22) of the base (20). In the embodiment of FIG. 4, the base (20) is in the form of a ring. The affixing material generally fixes the aesthetic item (30) in a predetermined orientation relative to the reflective upper surface (22). Thus, the aesthetic item (30) is located at least proximal the reflective upper surface (22). In the illustrated embodiment of FIG. 4, multiple aesthetic items (30) are located along the circumference of the ring-shaped base (20). In the illustrated embodiment of FIG. 4, the surrounding material (50) is also in the shape of a ring, and includes a recess for holding ring-shaped base (20). The surrounding material (60) of FIG. 4 also forms at least a portion of the human adornment apparatus (60), with the human adornment apparatus (60) being in the form of a ring. Thus, the surrounding material (50) and the human adornment apparatus (60) may be integral, and the surrounding material (50) and the human adornment apparatus (60) together may be monolithic. In other embodiments (not illustrated), the surrounding material (50) and the human adornment apparatus (60) may be non-integral, such as when a separate ring is attached to the bottom of surrounding material.

Referring now to FIG. 5a, another embodiment of a decorative article (10) in the form of a cufflink is illustrated. Like the decorative article (10) of FIG. 2a, the decorative article (10) includes at least one base (20), at least one aesthetic item (30), and an affixing material (not illustrated) disposed on at least a portion of the reflective upper surface (22) of the base (20). The affixing material generally fixes the aesthetic item (30) in a predetermined orientation relative to the reflective upper surface (22). Thus, the aesthetic item (30) is located at least proximal the reflective upper surface (22). In the embodiment of FIG. 5a, the decorative article (10) also includes a surrounding material (50) and an integral human adornment apparatus (60). In the embodiment of FIG. 5a, the surrounding material (50) includes a recess for holding base (20), and an integral human adornment apparatus (60) (i.e., the surrounding material forms at least a portion of the human adornment apparatus (60)). In the illustrated embodiment, the human adornment apparatus (60) is in the form of a clasp (62) and a post (64) for use in connecting the cufflink to clothing. Thus, the surrounding material (50) and the human adornment apparatus (60) may be integral, and the surrounding material (50) and the human adornment apparatus (60) together may be monolithic. The illustrated embodiment of FIG. 5a also includes optional cover (40). In other embodiments (not illustrated), the surrounding material (50) and the human adornment apparatus (60) may be non-integral, such as when a clasp and post are attached to the bottom of surrounding material to form a cufflink.

Referring now to FIG. 5b, another embodiment of a decorative article (10) in the form of a cufflink is illustrated. The illustrated embodiment of FIG. 5b is similar to that of FIG. 5a, except that multiple aesthetic items (30) are included.

### Inlaid Material(s)

The decorative article (10) may include one or more inlaid materials proximal the at least one aesthetic item (30). The inlaid material may be different than the surrounding material (50) in that the inlaid material may be proximal the reflective upper surface (22) of the base (20), but does not surround the base (20). The inlaid material is also generally not considered an aesthetic item (30). In this regard, an inlaid material may be disposed on a portion of the upper surface of the affixing material and/or the optional cover (40). In one embodiment, the inlaid material may at least partial surround the at least one aesthetic item (30). The inlaid material may be any suitable material, such as a suitable retaining ring material and the like. Thus, the inlaid material may have a planar upper and/or lower surface. The inlaid material may be any suitable color.

These and other aspects, advantages, and novel features of the decorative articles described herein are set forth in part in the description that follows, and will become apparent to those skilled in the art upon examination of the following description and figures, or may be learned by practicing the disclosure.

### BRIEF DESCRIPTION OF THE DRAWINGS

FIGS. 1a-1b are schematic, perspective views illustrating one embodiment of a new decorative article.

FIG. 2a is a photograph of a new decorative article having a surrounding material and a human adornment apparatus.

FIG. 2b is a photograph of a new decorative article having a surrounding material and a human adornment apparatus, where the surrounding material includes multiple distinct portions.

FIGS. 3a-3b are photographs of new decorative articles in the form of a ring having a base located on an upper surface of the ring.

FIG. 4 is a photograph of a new decorative article in the form of a ring having a base located about a circumference of the ring.

FIGS. 5a-5b are photographs of new decorative articles in the form of a cufflink.

FIGS. 6a-6c are photographs of new decorative articles having one or more sculptural items as the aesthetic item.

FIGS. 7a-7b are graphs illustrating reflectivity measurements as a function of wavelength for various materials of Example 1.

FIGS. 8a-8b are graphs illustrating reflectivity data and photopic response as a function of wavelength for various materials of Example 1.

FIGS. 9a-9b are graphs illustrating reflectivity measurements as a function of wavelength for various materials of Example 1.

FIG. 10 is a graph illustrating reflectivity differential as a function of wavelength for various materials, where the reflectivity differential is the difference between (a) a reflectivity measurement of a surface having a “mirror finish of 0.05 micron” and (b) a reflectivity of an unpolished surface having a 600 grit finish following an initial surface grinding, for a given wavelength of light.

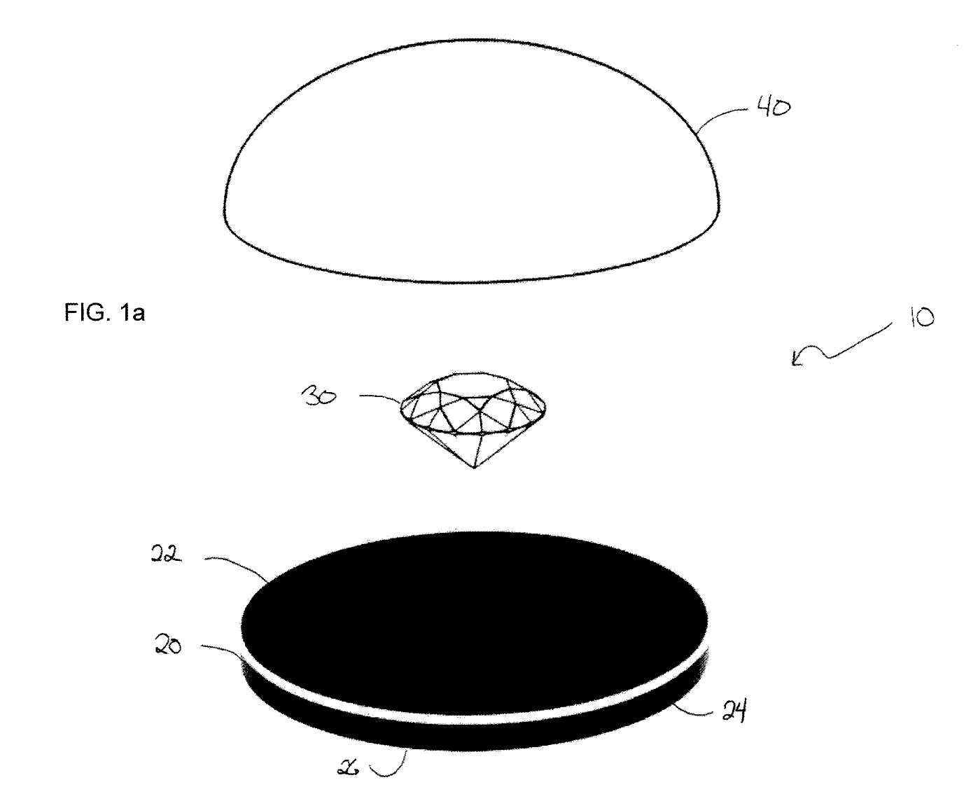

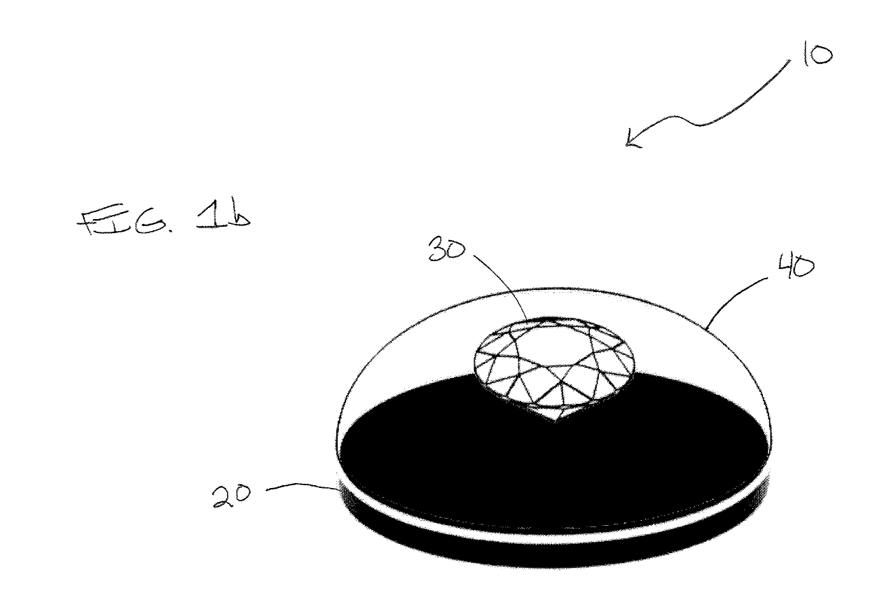

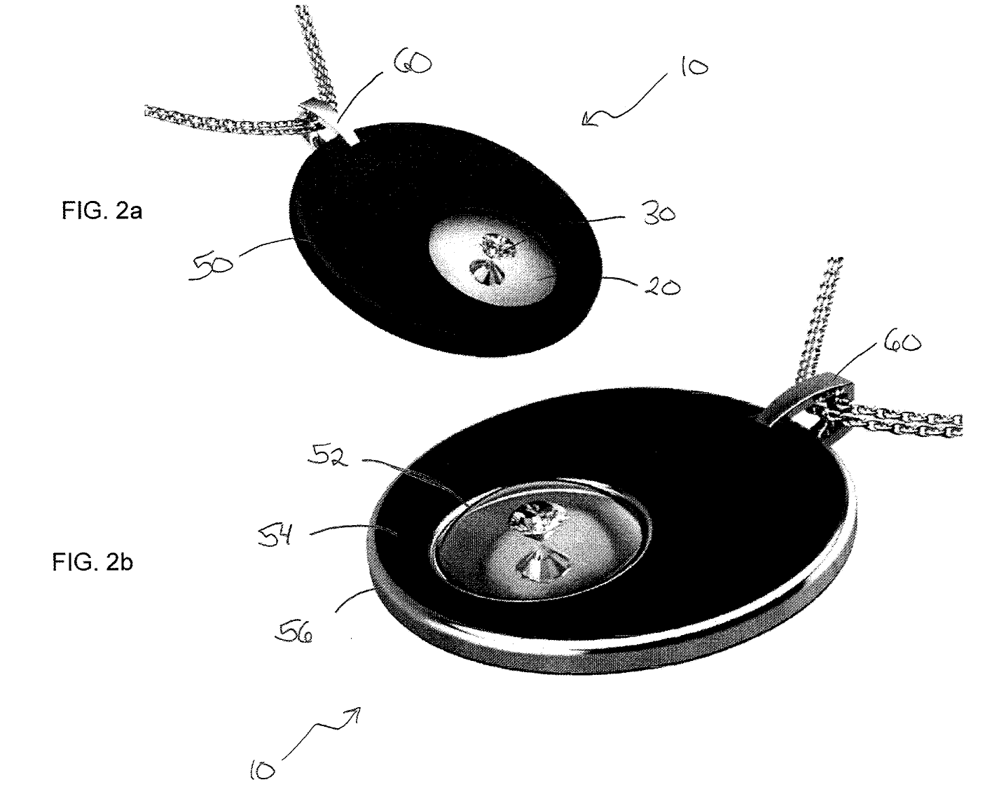

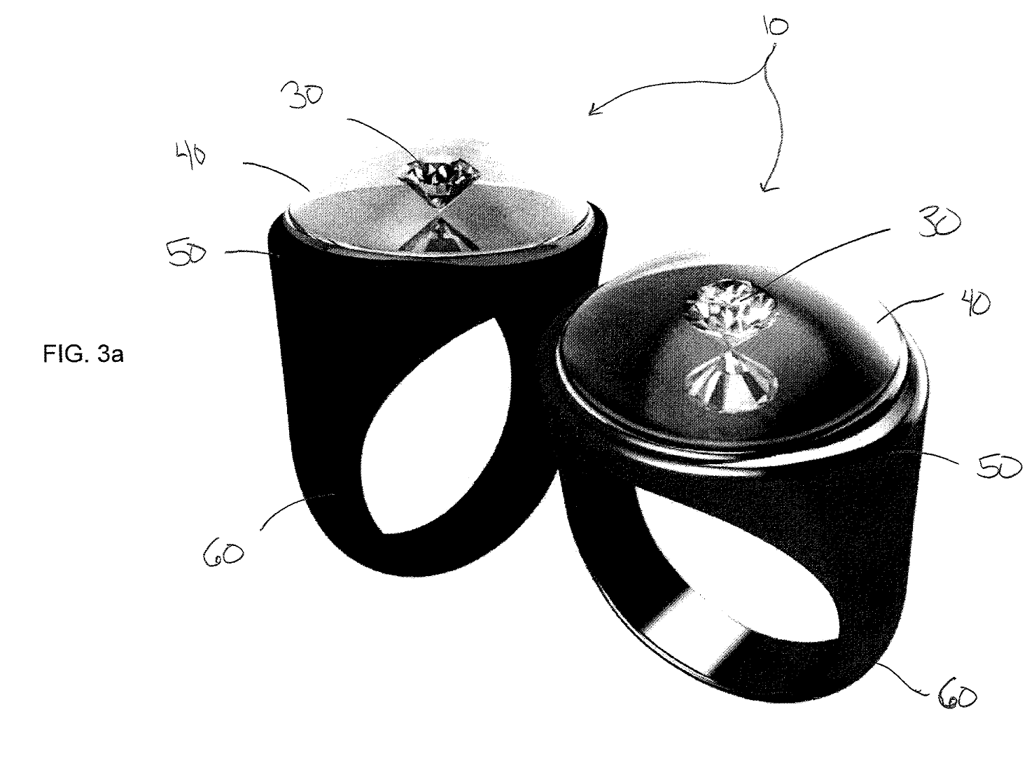

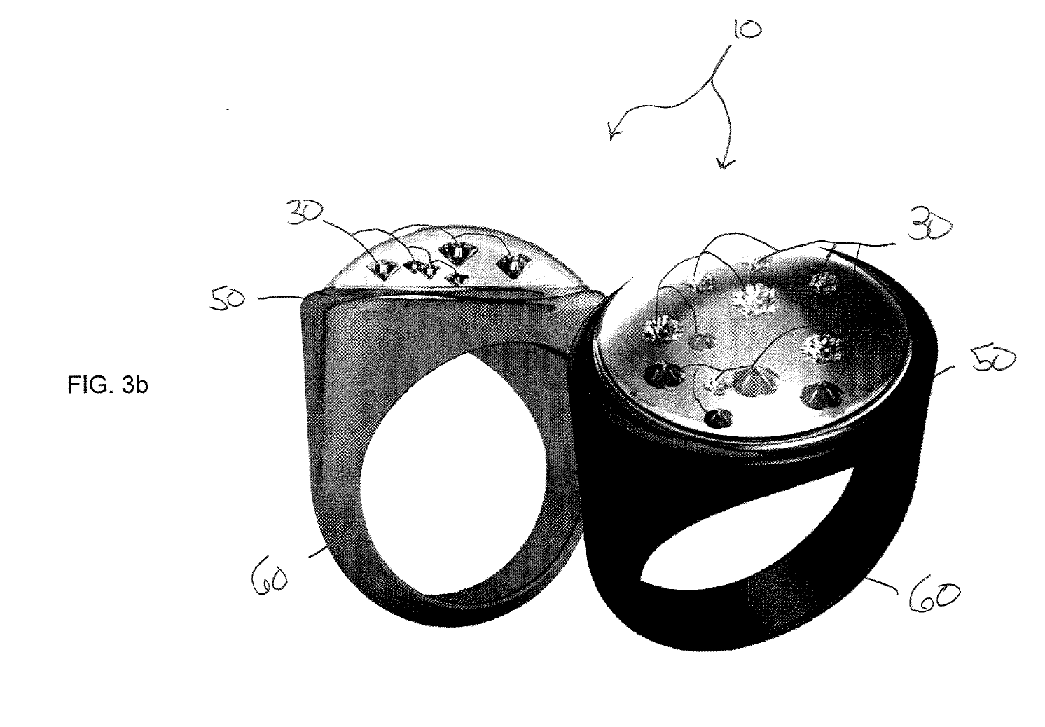

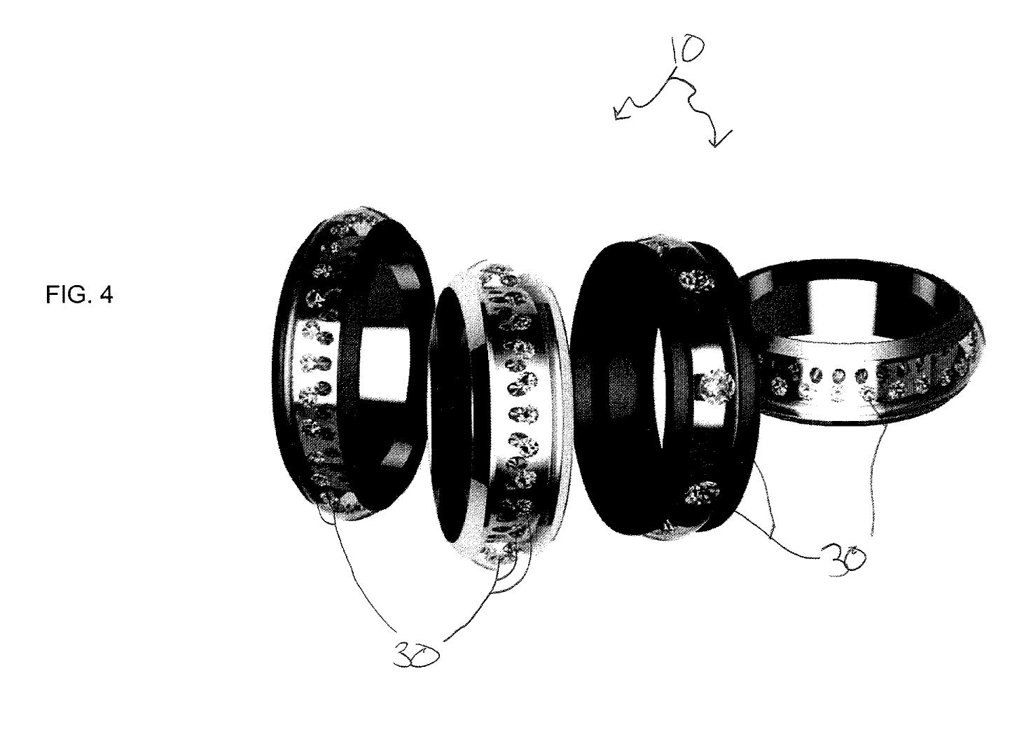

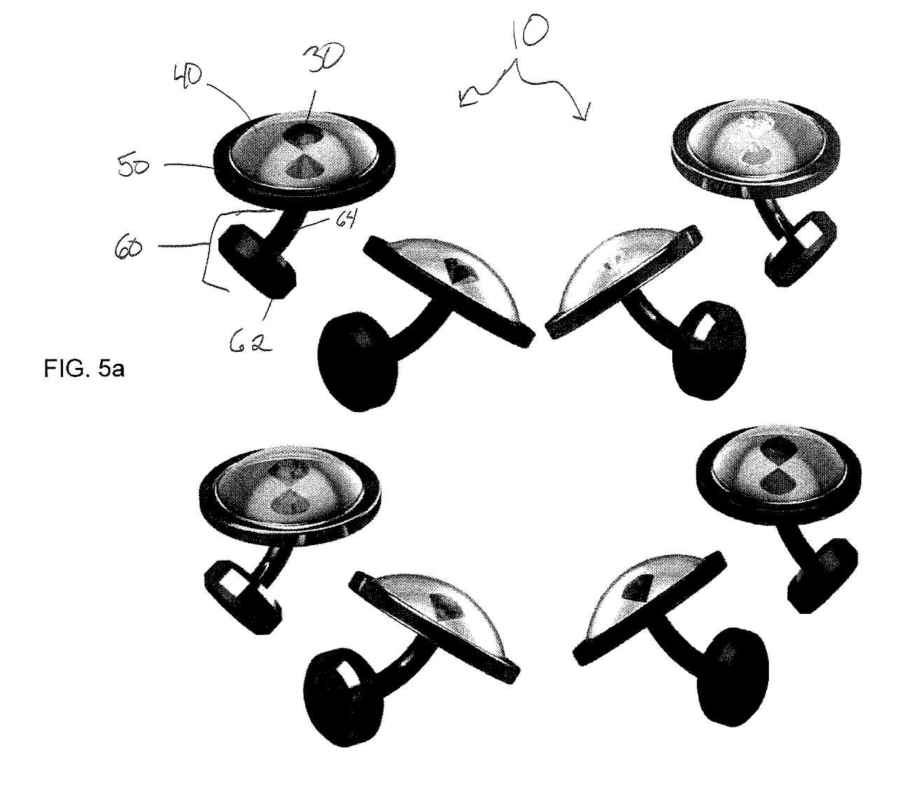

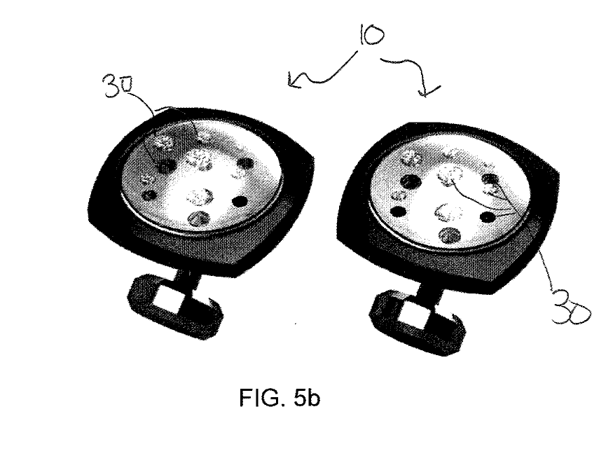

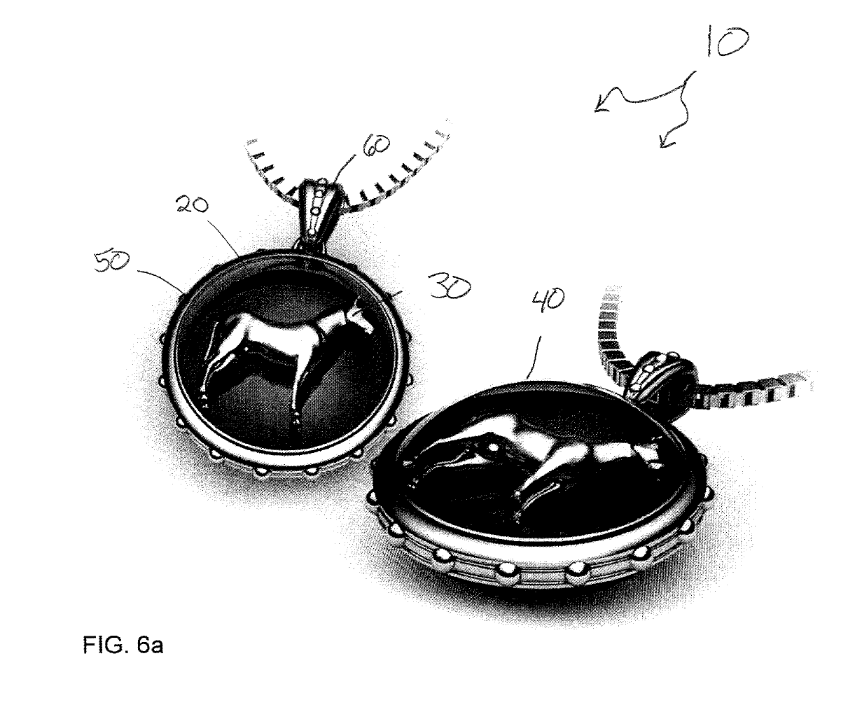

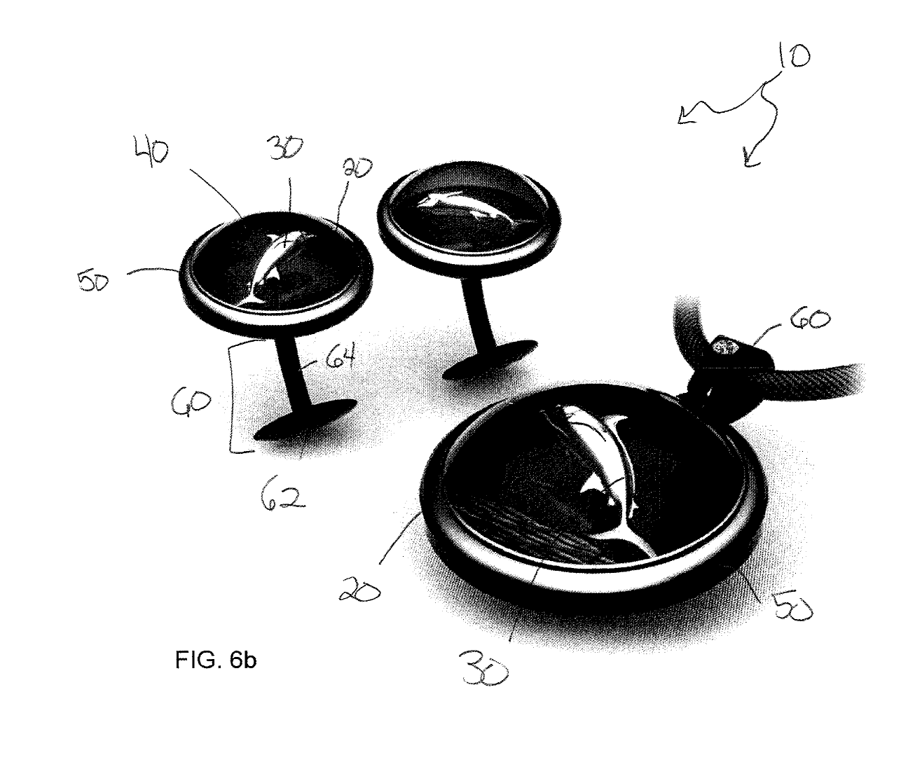

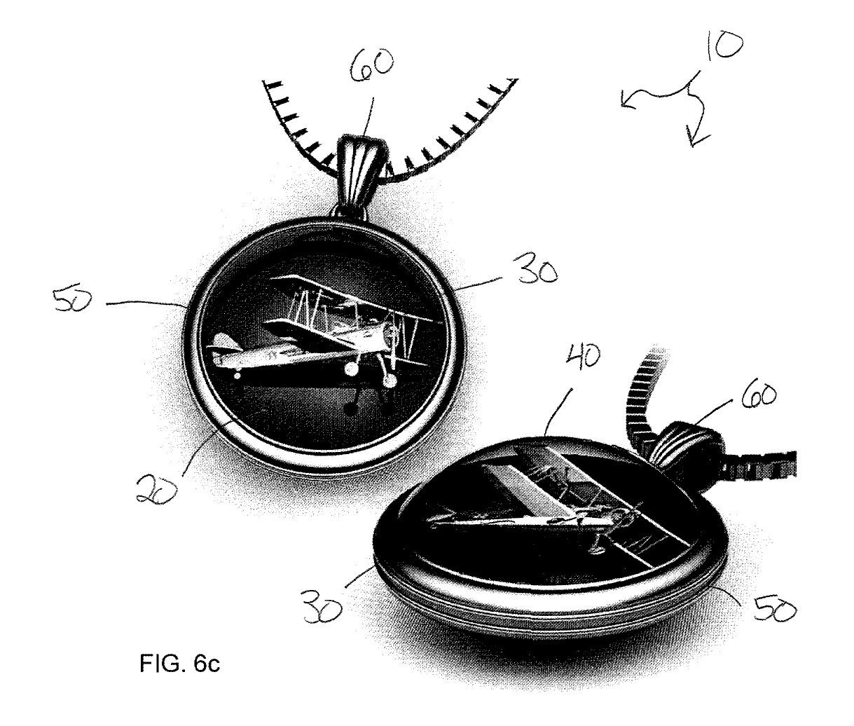

### DETAILED DESCRIPTION

### Example 1

Charges of elemental silicon (Dow Corning, PV1101, 99.999% purity level silicon), and metals selected from the appropriate eutectic compositions of Chromium (Atlantic Metals, 99.99%), Cobalt (Atlantic Metals, 99.95%), Titanium (Atlantic Metals, 99.995%) and aluminum (Atlantic metals, 99.99%) of the appropriate ratios (listed in Table 1, below) were melted and then directionally solidified in a graphite crucible (6.5″×3.5″×2.5″) under vacuum.

TABLE 1
Silicon Eutectic Alloys - Charged Weights

| Base Eutectic | Si (g) | Cr (g) | Ti (g) | Co (g) | Al (g) |
|---|---|---|---|---|---|
| Si—CrSi₂ | 1292 | 408 | — | — | — |
| Si—CrSi₂ | 1296.4 | 408 | — | — | 34 |
| Si—TiSi₂ | 1332 | — | 369 | — | — |
| Si—TiSi₂ | 1332.2 | — | 369.7 | — | 8.5 |
| Si—CoSi₂ | 933 | — | — | 563.2 | — |

Sample coupons from each composition were sectioned using a diamond wheel saw and polished using diamond bonded metal pads and diamond abrasive slurry to a mirror finish of 0.05 micron. Other sample coupons were finished with a 600 grit finish following an initial surface grinding.

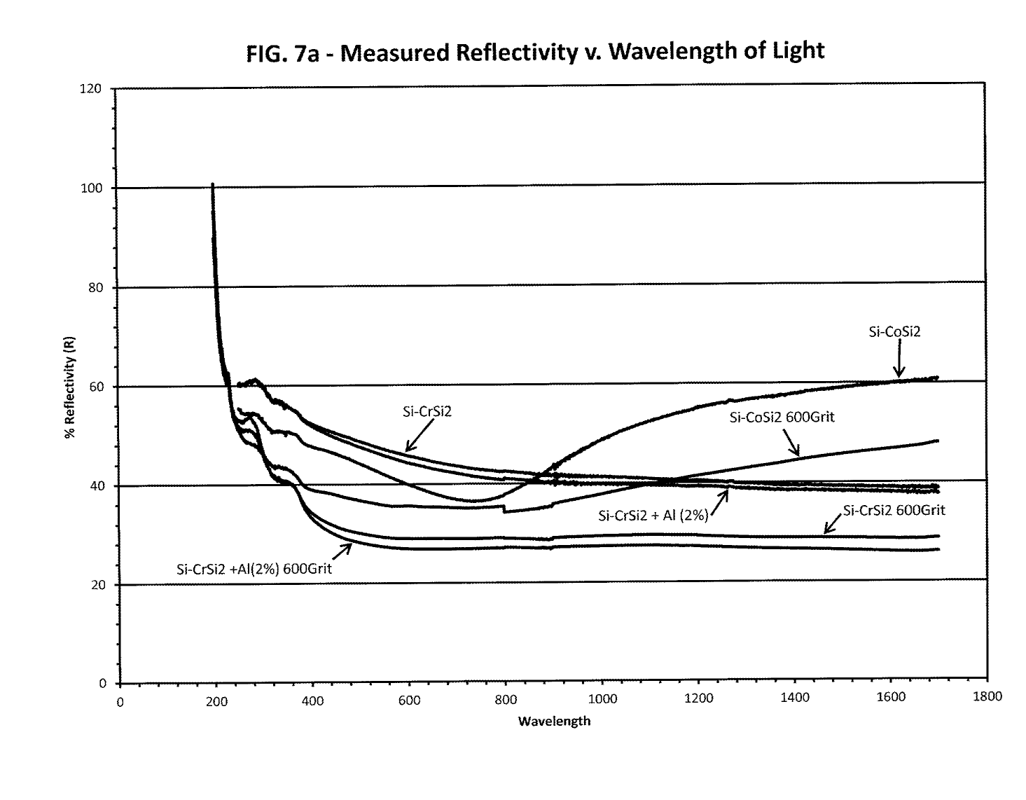

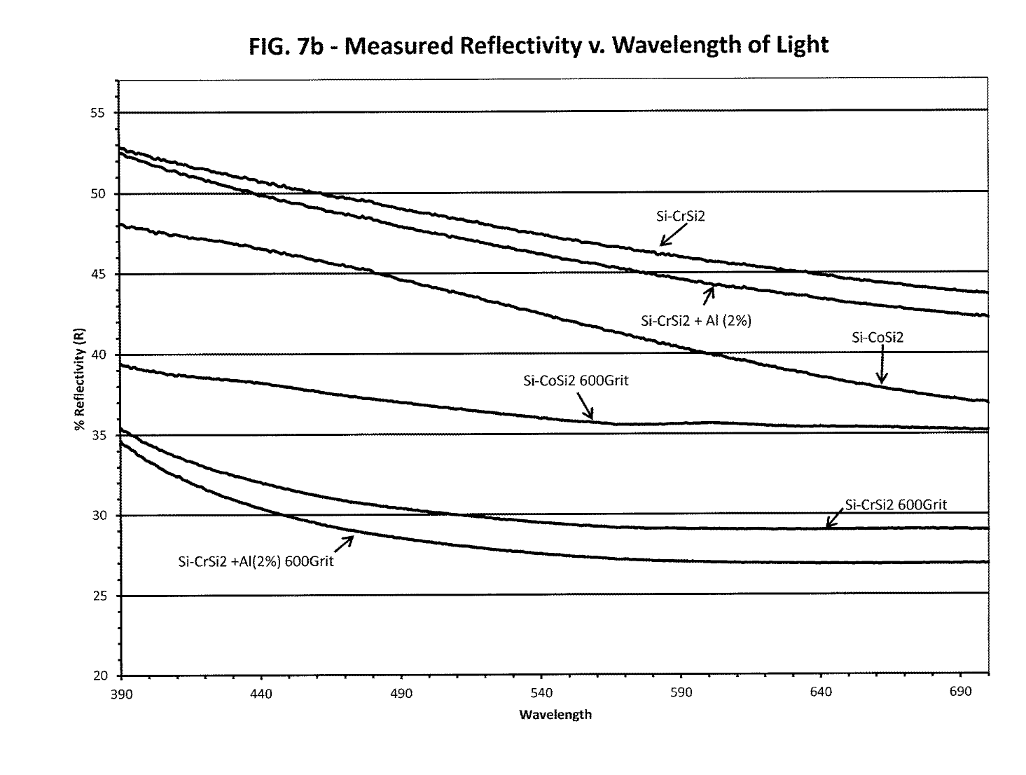

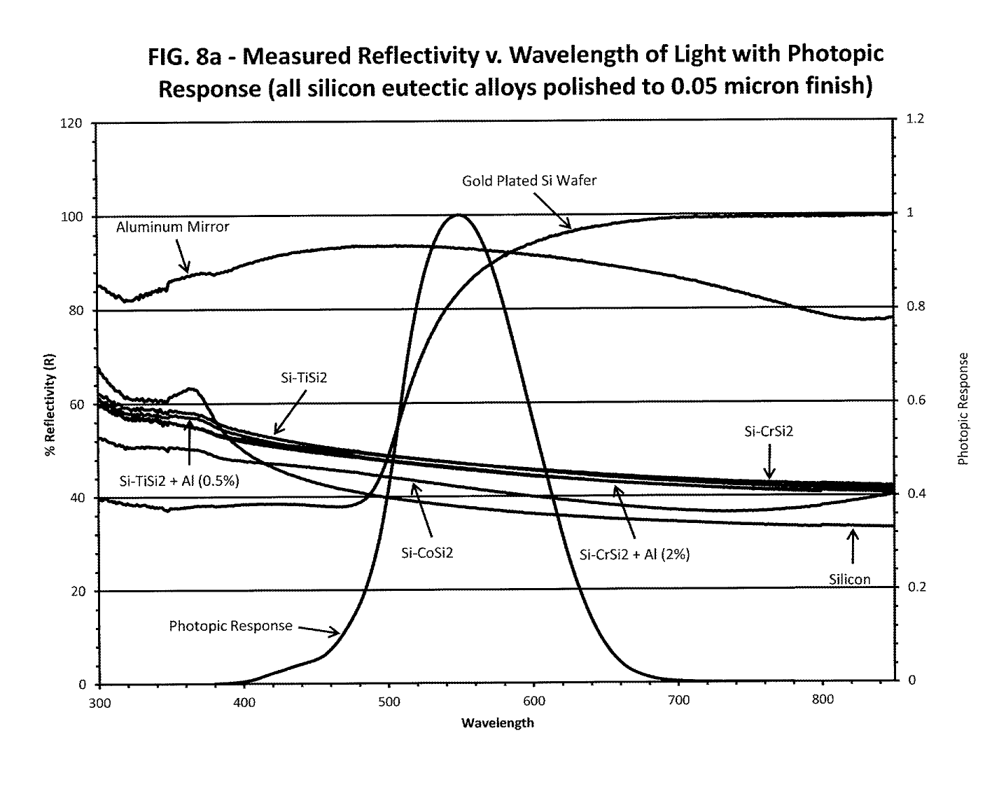

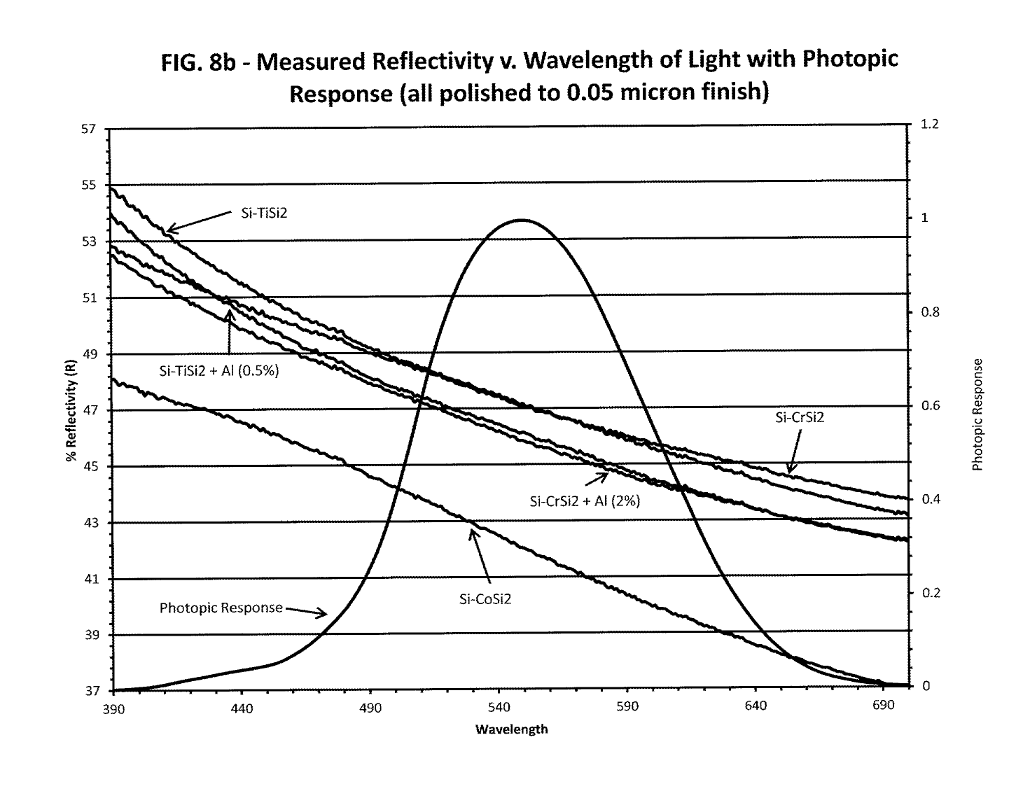

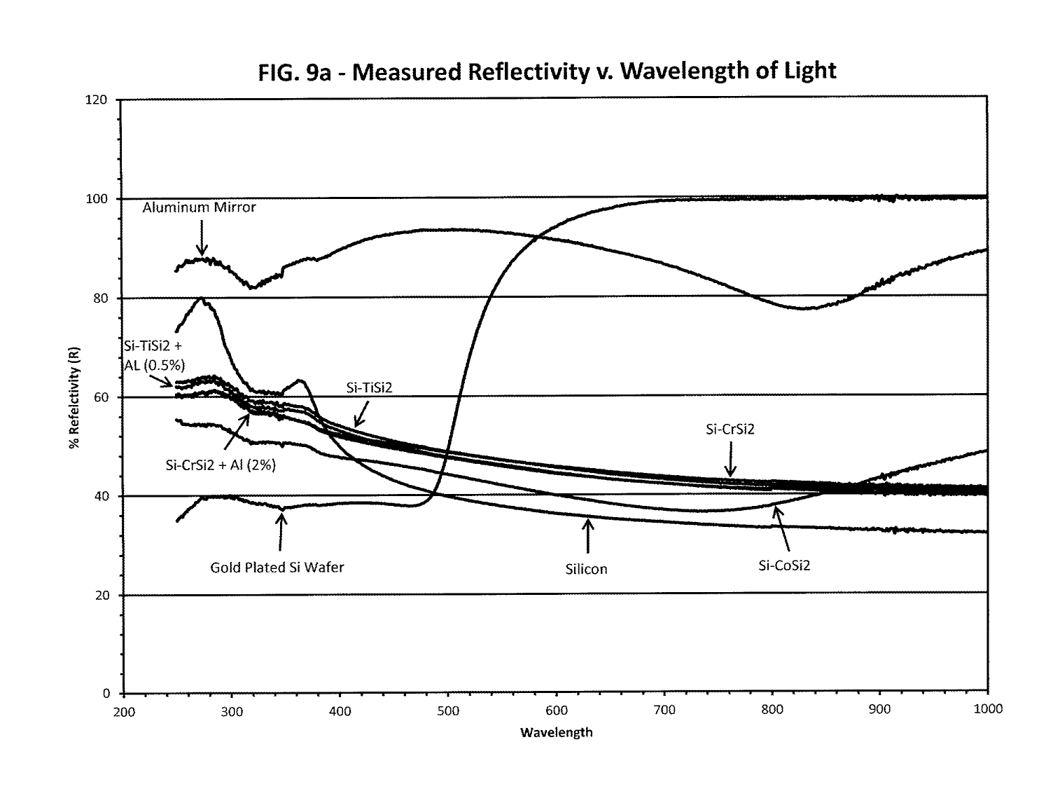

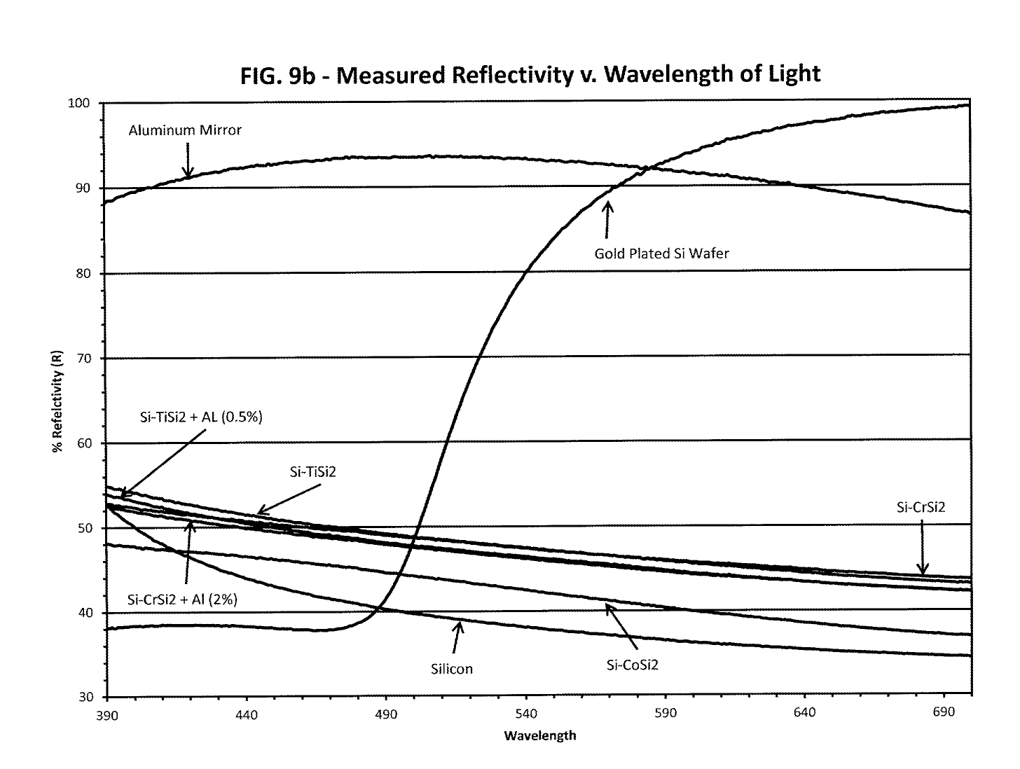

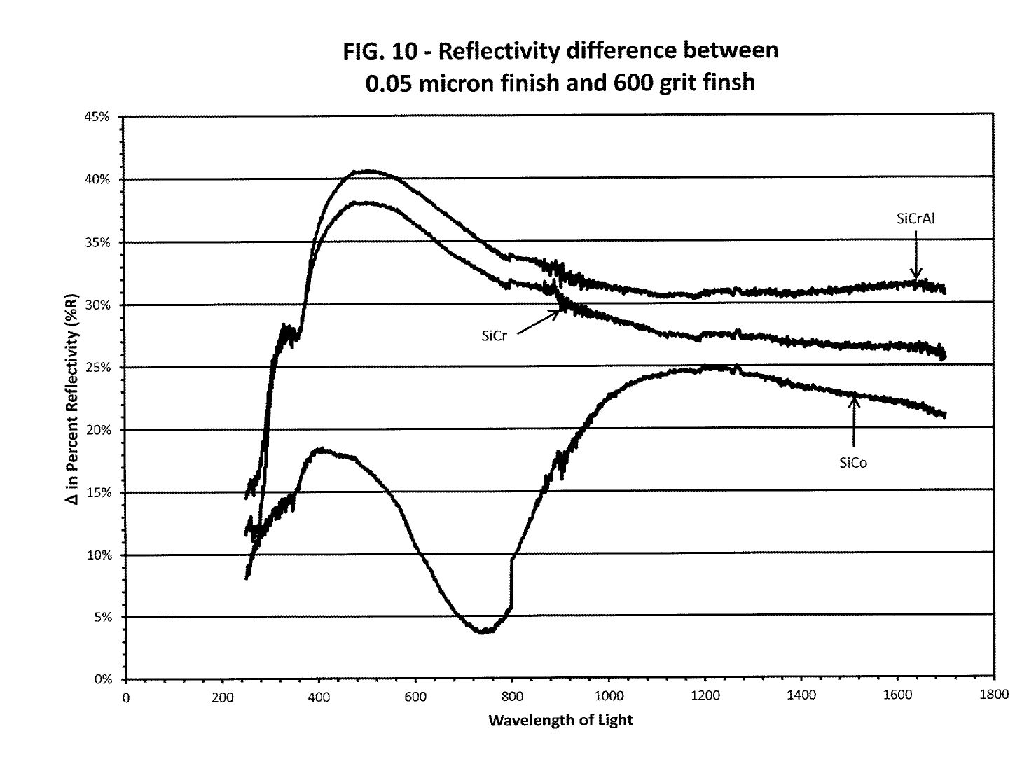

UV-Vis reflectivity analysis of the samples was performed using an Agilent Cary 5000 Spectrophotometer in diffuse reflection mode from 250 to 1700 nm. Comparison of alloy samples was performed using a gold plated silicon wafer, a polished Aluminum mirror and a polished silicon wafer. Various reflectivity results are shown in FIGS. 7a-7b, 8a-8b, 9a-9b and 10. Visual analysis of the materials indicates that the materials would be fit for decorative applications.

While various embodiments of the present disclosure have been described in detail, it is apparent that modifications and adaptations of those embodiments will occur to those skilled in the art. However, it is to be expressly understood that such modifications and adaptations are within the spirit and scope of the present disclosure.

What is claimed is:

1. A decorative article (10) comprising:
(a) a base (20) having a reflective upper surface (22);
(b) an aesthetic item (30) located at least proximal the reflective upper surface, wherein the aesthetic item is selected from the group consisting of (a) one or more precious stones, (b) one or more precious metals, (c) one or more sculptural items, and (d) combinations thereof;
(c) an affixing material disposed on the reflective upper surface;
wherein the affixing material fixes the aesthetic item in a predetermined orientation relative to the reflective upper surface.

2. The decorative article of claim 1, wherein the base comprises a silicon eutectic alloy.

3. The decorative article of claim 1, wherein the base comprises a glass.

4. The decorative article of claim 1, wherein the base is a metal, metal alloy, or composite intermetallic.

5. The decorative article of claim 1, wherein the affixing material is translucent or transparent.

6. The decorative article of claim 1, wherein the affixing material is colored.

7. The decorative article of claim 1, wherein the affixing material comprises a polymer.

8. The decorative article of claim 7, wherein the polymer is a silicone polymer.

9. The decorative article of claim 7, wherein the polymer is an organic polymer.

10. The decorative article of claim 1, comprising:
(d) a human adornment apparatus connected to the base.

11. The decorative article of claim 1, wherein the human adornment apparatus comprises a clasp.

12. The decorative article of claim 1, wherein the human adornment apparatus comprises a ring.

13. The decorative article of claim 1, comprising:
a surrounding material at least partially surrounding at least a portion of an outer edge of the base.

14. The decorative article of claim 13, wherein the surrounding material comprises a precious or semi-precious metal.

15. The decorative article of claim 13, wherein the surrounding material comprises a recess, and wherein the base is at least partially disposed within the recess of the surrounding material.

16. The decorative article of claim 1, comprising:
a cover connected to at least a portion of the base.

17. The decorative article of claim 16, wherein the cover is transparent or translucent.
